(19) United States
(12) Patent Application Publication
(10) Pub. No.: US 2025/0182450 A1
(43) Pub. Date: Jun. 5, 2025

(54) SYSTEM AND METHOD FOR WEAPON DETECTION WITH POSE ESTIMATION

(71) Applicants: CARNEGIE MELLON UNIVERSITY, Pittsburgh, PA (US); ANYVISION INTERACTIVE TECHNOLOGIES, LTD., Holon (IL)

(72) Inventors: Marios Savvides, Pittsburgh, PA (US); Han Zhang, Pittsburgh, PA (US); Dieter Joecker, Pittsburgh, PA (US); Fangyi Chen, Pittsburgh, PA (US)

(73) Assignees: CARNEGIE MELLON UNIVERSITY, Pittsburgh, PA (US); ANYVISION INTERACTIVE TECHNOLOGIES, LTD., Holon (IL)

(21) Appl. No.: 18/845,098

(22) PCT Filed: Apr. 3, 2023
(86) PCT No.: PCT/US23/17299

§ 371 Date: Sep. 9, 2024

Related U.S. Application Data
(60) Provisional application No. 63/326,529, filed on Apr. 1, 2022.

(51) Int. Cl. G06V 10/764; G06T 7/70; G06V 10/82; G06V 20/52; G06V 40/10; G06V 40/20

(52) U.S. Cl. CPC G06V 10/764; G06T 7/70; G06V 10/82; G06V 20/52; G06V 40/107; G06V 40/28

(57) ABSTRACT

Disclosed herein is an artificial intelligence-based system and method for detecting possible danger in a scene contain one or more people. Individual people are detected and it is determined if one of the person's limbs is in a threatening position and if the hand of the person is holding a weapon. The system uses neural networks to detect people and weapons and classifiers to determine a probability of danger, based on the evaluation of the position and state of the limbs of the person.

### RELATED APPLICATIONS

This application claims the benefit of U.S. Provisional Patent Application No. 63/326,529, filed Apr. 1, 2022, the contents of which are incorporated herein in their entirety.

### BACKGROUND

There has been a rising trend of mass shootings and active shooter incidents in the past decade, especially in the United States. Any venue where crowds of people congregate is a potential target for a mass shooter. These targets include, for example, classrooms, theaters, restaurants, stadia, etc. Mass shootings are defined as incidents wherein four or more people, not including the shooter, are injured or killed. In 2022, the United States averages more than one mass shooting per day. In a recent poll, 6 of 10 Americans live in fear of a mass shooting incident in their community.

There is currently no effective way to prevent such mass shootings or to mitigate the damage caused by these deranged individuals. Recent advancements in object detection driven by machine learning technologies have improved the understanding of vulnerable venues to better address mass shootings (or other dangerous circumstances) and to mitigate the number of victims. However, a need still exists to provide improvements in object detection to augment existing security systems, which often include closed-circuit video sources, to better understand the environment and detect potential shooters before mass casualties occur.

### SUMMARY

To address the issues identified above, disclosed herein is an artificial intelligence-based system and method for detecting criminal activities related to guns from surveillance camera feeds. Camera feeds providing still frame and/or video frame captured images. The system identifies a body structure of a human with a limb or hand tagged with atomic action attributes. Bounding boxes containing firearms will also be tagged with an attribute (e.g., being held/not being held), by a separate tagging classifier for this task. The system will further establish human-gun association. The output from the pose estimator and gun detector will together serve as the input to a reasoning module which will determine the probability that a person in a scene represents a danger.

### BRIEF DESCRIPTION OF THE DRAWINGS

By way of example, a specific exemplary embodiment of the disclosed system and method will now be described, with reference to the accompanying drawings, in which:

FIG. 1 is a stylized illustration of an exemplary scene to which the system of the claimed embodiments may be used showing multiple people in a crowd with one person wielding a weapon.

FIG. 2 is a flowchart of a first embodiment of the system in which detectors are used to detect both people and weapons in the scene.

FIG. 3 is a flowchart of a second embodiment of the system in which detectors are used to detect people and hands and further in which the detected hands are classified to determine if they are holding a weapon.

FIG. 4 is a flowchart of third embodiment of the system in which a state reasoning network determines whether hands attached to an arm in a pose of interest is holding an object and, if so, the object is identified as being a weapon or not being a weapon.

### DETAILED DESCRIPTION

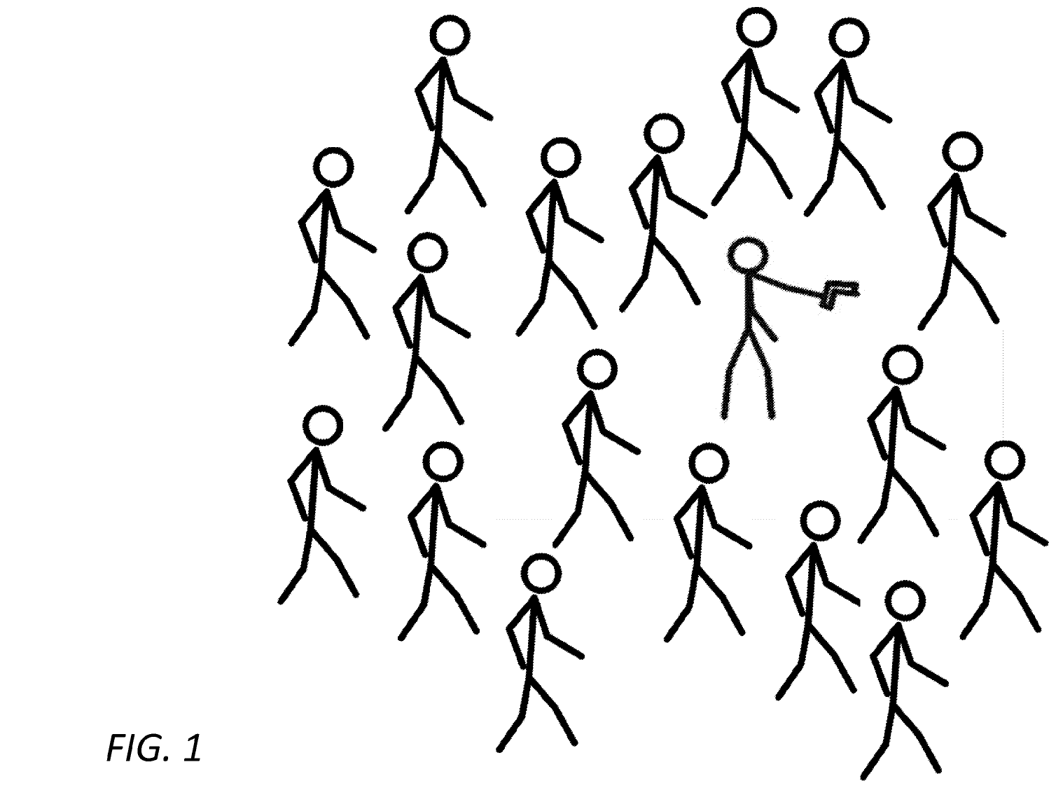

The claimed embodiments are directed to a system and method for detecting dangerous individuals in a scene. The individuals are considered dangerous if they are holding a weapon (e.g., pistols, rifles, knives, etc.) and have a limb in a threatening position (i.e., arm extended, etc.). FIG. 1 is a stylized scene using stick figures showing one of the figures holding a pistol in an extended position. This figure would be tagged as potentially dangerous based on (1) having the arm in an extended position; and (2) having a gun in the hand of the extended arm.

Detecting guns from surveillance camera feeds can be challenging. To achieve robust performance, the claimed embodiments not only detect guns but also rely on human-object-interactions.

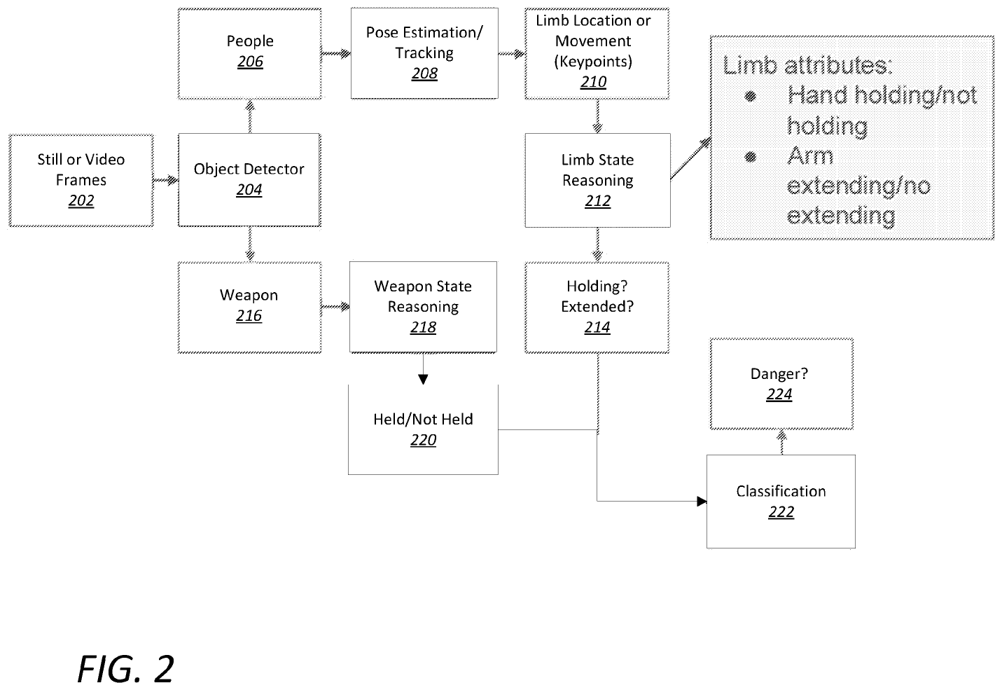

A first embodiment is shown in flowchart form in FIG. 2. The input data 202 may be either a still frame or a continuous flow of frames (i.e., video). Input data 202 is input to object detector 204. In one embodiment, object detector 204 performs people detection and weapon detection as bounding boxes. In a variation of this embodiment, object detector 204 may be embodied as two detectors, one capable of performing people detection and another capable of performing weapon detection. In one embodiment, object detector 204 is preferably a neural network trained to detect the objects of interest, in this case, people and/or guns.

The output of object detector 204 is one or more people 206, detected as human pose structures in a bounding box with 2D coordinates indicating keypoints in the frame. In these embodiments, the keypoints of particular interest are the wrist joint, the elbow joint and the shoulder joint, however, any or all common keypoints may be detected. In some embodiments, cropping is performed on a features map output from detector 204 to isolate the keypoints of interest and resize the bounding box to a fixed size.

Based on the identified keypoints the system performs pose estimation (in the case of still frames) or pose tracking (in the case of video) at 208, resulting in a location of a limb or movement of a limb in step 210. In the case of video, video may be chopped into small time segments, for example, segments of 5 seconds or a predetermined number of video frames, and the frames within each segment analyzed as a group. In one embodiment, pose estimation at step 208 is performed by a neural network.

Once the location or movement of limbs 210, is identified, limb state reasoning is performed at 212 is determined if the limb location or movement is of particular interest. In various embodiments, limb state reasoning 212 will determine if the arm and hand of the any of the detected people is in a pose of interest. Limb state reasoning 212 may detect different poses of interest for different types of weapons. For example, an arm holding a pistol will or knife will typically be extended away from the body and pointed toward a particular direction, while an arm prepared to fire a rifle may be cocked such that the hand engages the trigger portion of the rifle. In addition, limb state reasoning 212 may determine if a person having an extended arm is carrying anything in the hands or has an arm extended for a different reason, for example, pointing at something. The result of the limb state reasoning 212 is shown in step 214, indicating whether the arm is extended or in a different position for a different type of weapon and/or is holding anything. In one embodiment, limb state reasoning 212 is performed by a trained neural network.

The system is also capable of detecting weapons from the still or video frames 202. object detector 204, acting either serially or in parallel with the detection of people, detects weapons at 216. Any detected weapons may be detected as bounding boxes. As previously mentioned, object detector 204, for detecting weapons 216 may be the same detector 204 is used for detecting people 206 or may be separately trained neural network. At 218, a weapon state reasoning step 218 is performed to determine if a weapon 216 is being held or not held. Not all weapons within the still or video frames 202 may be held, for example, object detector 204 may detect a weapon, such as a pistol, carried in a holster or a rifle carried slung over a person's back. Weapon reasoning state 218 results in a conclusion at 220 of whether the weapon is held or not held.

At 222, a classification step is performed based on the results of the held/not held status at 220 in the holding or extended status at 214. The output of the classification is a determination of whether the person in the scene represents a danger or not. A person may be determined to represent a danger if, for example, the person's arm is in an extended position and the weapon is being held in the hand of the extended arm (e.g., in the case of the weapon being a pistol), as shown in FIG. 1. Other poses may be determinative as indicating a danger for other types of weapons. Classifier 222 may be trained neural network.

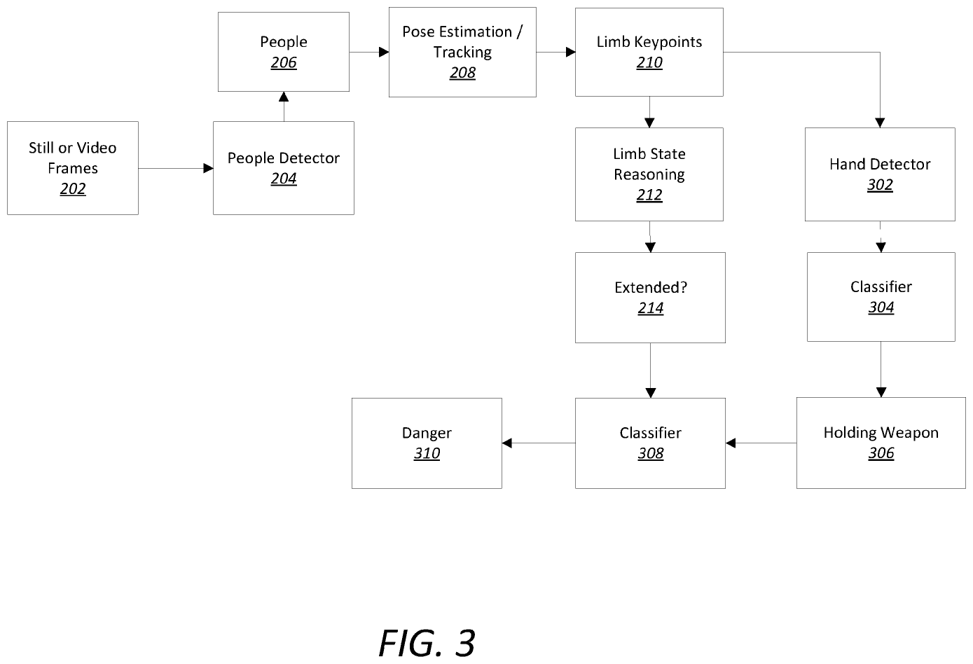

FIG. 3 shows a variation of the embodiment of FIG. 2 wherein the weapon detector 204 has been eliminated. In this embodiment, steps 202-214 are identical to the corresponding steps in the embodiment shown in FIG. 2. In this embodiment, and detector 302 detects hands within still or video frames 202 as bounding boxes. In one embodiment, hand detector 302 may be a trained neural network and may take as input the still or video frames 202, the detected people 206 or the keypoints 210. Once a hand has been detected at 302, the bounding boxes are input to a classifier 304 to determine if the hand is holding a weapon. The determination of whether the hand is holding a weapon at 306 is an input to a second classifier 308 which also takes as input the determination of whether the hand is an extended position 214 (or another position of interest for a different type of weapon). Classifier 308 evaluates whether or not the hand is holding the weapon and if one of the arms is in an extended position and provides an evaluation of danger at 310. Classifiers 304 and 308 may be trained neural networks.

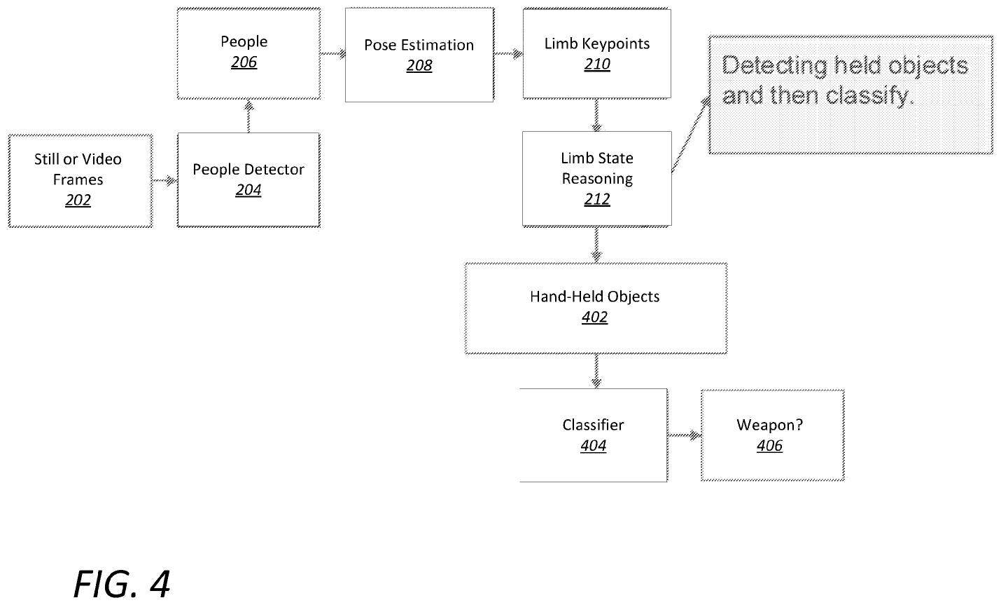

FIG. 4 shows yet another variation of the embodiment of FIG. 2 wherein the limb state reasoning step 212 also determines whether the hand is holding an object 402. Handheld objects may be identified by bounding boxes. A neural network trained as classifier 404 to classify handheld objects 402 as either weapons or not weapons is then applied and, at 406, it is determined if the hand is holding a weapon. Limb state reasoning 212 may operate as previously discussed to also determine whether the person's arm is in a pose of interest, for example, extended if the handheld object is a pistol or cocked if the handheld object is a rifle.

As would be realized by one of skill in the art, many variations on the implementations discussed herein fall within the intended scope of the invention. Moreover, it is to be understood that the features of the various embodiments described herein are not mutually exclusive and can exist in various combinations and permutations, even if such combinations or permutations were not made express herein, without departing from the spirit and scope of the invention. Accordingly, the method and system disclosed herein are not to be taken as limitations on the invention but as an illustration thereof. The scope of the invention is defined by the claims which follow.

1. A system comprising:
one or more still or video cameras;
one or more object detector modules for detecting people and weapons in a scene captured by the cameras;
a pose estimation model for determining a pose of people detected by the object detector modules;
a limb state reasoning module for determining a position and state of the limbs in the poses estimated by the pose estimation module;
a weapon state reasoning module to determine if weapons detected by the object detector modules are held in the hand of a person detected by the object detector modules; and
a classifier to determine a probability of danger based on outputs of the limb state reasoning module and the weapon state reasoning module.

2. The system of claim, 1 wherein the pose estimation module determines a position of a plurality of keypoints defining a pose of a person detected by the object detector modules.

3. The system of claim 2 wherein the limb state reasoning module determines a position or movement of a limb of a detected person based on keypoints defining positions of the wrist, elbow and shoulder of the person.

4. The system of claim 3 wherein the limb state reasoning module determines if a position or movement of the limb is of interest, given a variety of different types of possible weapons.

5. The system of claim 1 wherein the cameras are video cameras and further wherein the pose estimation module tracks a pose of detected people and weapons over a predetermined number of video frames.

6. The system of claim 1 wherein the one or more object detectors detect people and weapons as bounding boxes.

7. A system comprising:
one or more still or video cameras;
a people detector module for detecting people in a scene captured by the cameras;
a pose estimation model for determining a pose of people detected by the people detector module;
a limb state reasoning module for determining a position of the limbs in the poses estimated by the pose estimation module;
a hand detector module for detecting hands in the scene captured by the cameras;
a first classifier to determine if hands detected by the hand detector module are holding a weapon; and
a second classifier to determine a probability of danger based on outputs of the limb state reasoning module and the first classifier.

8. The system of claim, 7 wherein the pose estimation module determines a position of a plurality of keypoints defining a pose of a person detected by the object detector modules.

9. The system of claim 8 wherein the limb state reasoning module determines a position or movement of a limb of a detected person based on keypoints defining positions of the wrist, elbow and shoulder of the person.

10. The system of claim 9 wherein the limb state reasoning module determines if a position or movement of the limb is of interest, given a variety of different types of possible weapons.

11. The system of claim 7 wherein the cameras are video cameras and further wherein the pose estimation module tracks a pose of detected people and weapons over a predetermined number of video frames.

12. The system of claim 7 wherein the people detector module and the hand detector module detect people and hands as bounding boxes.

13. A system comprising:
one or more still or video cameras;
a people detector module for detecting people in a scene captured by the cameras;
a pose estimation model for determining a pose of people detected by the people detector module;
a limb state reasoning module for determining a position of the limbs in the poses estimated by the pose estimation module;
a handheld objects detector module for detecting handheld objects in the scene captured by the cameras; and
a classifier to determine the handheld objects are weapons.

14. The system of claim, 13 wherein the pose estimation module determines a position of a plurality of keypoints defining a pose of a person detected by the object detector modules.

15. The system of claim 14 wherein the limb state reasoning module determines a position or movement of a limb of a detected person based on keypoints defining positions of the wrist, elbow and shoulder of the person.

16. The system of claim 15 wherein the limb state reasoning module determines if a position or movement of the limb is of interest, given a variety of different types of possible weapons.

17. The system of claim 13 wherein the cameras are video cameras and further wherein the pose estimation module tracks a pose of detected people and weapons over a predetermined number of video frames.

18. The system of claim 13 wherein the people detector module and the handheld object detector module detect people and handheld objects as bounding boxes.

19. A system comprising:
one or more still or video cameras;
a processor; and
software that, when executed by the processor, causes the system to:
detect one or more people in a scene provided by the cameras;
determine if limbs of the detected people are in positions of interest, given one or more different types of weapons;
determine if a weapon is detected in the scene and if the weapon is being held in a hand of a person; and
determine a probability of danger based on a limb being in a position of interest and a weapon being held in a hand of the limb in the position of interest.

20. The system of claim 19 wherein one or more of the cameras are video cameras and further wherein a movement of the limbs of detected people are tracked over a predetermined number of video frames.
